(19) United States
(12) Patent Application Publication
(10) Pub. No.: US 2013/0265329 A1
(43) Pub. Date: Oct. 10, 2013

(54) IMAGE PROCESSING APPARATUS, IMAGE DISPLAY SYSTEM, METHOD FOR PROCESSING IMAGE, AND IMAGE PROCESSING PROGRAM

(71) Applicant: CANON KABUSHIKI KAISHA, Tokyo (JP)

(72) Inventors: Takuya Tsujimoto, Kawasaki-shi (JP); Takao Tani, Tokyo (JP)

(21) Appl. No.: 13/909,960

(22) Filed: Jun. 4, 2013

Related U.S. Application Data
(63) Continuation of application No. PCT/JP2012/083831, filed on Dec. 27, 2012.

(30) Foreign Application Priority Data
Dec. 27, 2011 (JP) 2011-286786
Dec. 26, 2012 (JP) 2012-282782

(51) Int. Cl. G06T 11/60

(52) U.S. Cl. CPC G06T 11/60
USPC 345/629

(57) ABSTRACT

An image processing apparatus that generates image data regarding an imaging target to be displayed on the basis of pieces of data regarding divided images of the imaging target obtained by capturing an imaging range such that the pieces of data regarding divided images include overlap regions includes image data obtaining means for obtaining the plurality of pieces of data regarding divided images, image data selection means for automatically selecting, for each of the overlap regions, a piece of image data to be displayed from the plurality of pieces of data regarding divided images, and display control means for displaying, on an image display apparatus, each of the overlap regions using the piece of data regarding a divided image selected by the image data selection means.

### CROSS-REFERENCE TO RELATED APPLICATIONS

This application is a Continuation of International Patent Application No. PCT/JP2012/083831, filed Dec. 27, 2012, which claims the benefit of Japanese Patent Application No. 2011-286786, filed Dec. 27, 2011 and Japanese Patent Application No. 2012-282782, filed Dec. 26, 2012, all of which are hereby incorporated by reference herein in their entirety.

### TECHNICAL FIELD

The present invention relates to an image processing apparatus, and, more particularly, to digital image processing for observing an imaging target.

### BACKGROUND ART

In these years, in a pathological field, virtual slide systems that enable pathological diagnosis on displays by capturing images of test samples (subjects) disposed on prepared slides and by digitizing the images are attracting attention as an alternative to an optical microscope, which serves as a tool of pathological diagnosis. By digitizing images for pathological diagnosis using the virtual slide systems, existing images of test samples obtained by optical microscopes may be treated as digital data. As a result, merits such as quick remote diagnosis, explanation to patients using digital images, sharing of rare cases, and efficient education and training are expected to be produced.

In order to realize substantially the same operation as that of an optical microscope using a virtual slide system, the entirety of a test sample on a prepared slide needs to be digitized. By digitizing the entirety of the test sample, digital data created by the virtual slide system may be observed using viewer software that operates on a PC (Personal Computer) or a work station. The number of pixels when the entirety of the test sample has been digitized is normally hundreds of millions of pixels to billions of pixels, which is an extremely large amount of data.

The amount of data created by a virtual slide system is extremely large, and microscopic (enlarged images of details) and macroscopic (overview images of the entirety) observations become possible by performing enlarging and reducing processes using the viewer, which produces various advantages. By obtaining all necessary information in advance, low-magnification images and high-magnification images may be instantaneously displayed at a resolution and a magnification desired by a user. In addition, various pieces of information useful for pathological diagnosis may be provided by analyzing obtained digital data regarding an image in order to, for example, detect the shapes of cells and calculate the number of cells and the area ratios (N/C ratios) of cytoplasm to nuclei.

As a technology for obtaining a high-magnification image of such a subject, a method has been devised in which a high-magnification image of the entirety of the subject is obtained by using a plurality of high-magnification images obtained by capturing images of parts of the subject. More specifically, in PTL 1, a microscope system that divides a subject into divisions and captures images of the divisions and that combines the obtained images of the divisions with one another to display a composite image of the subject is disclosed. In PTL 2, an image display system that obtains a plurality of partial images of a subject by capturing an image a plurality of times while moving a stage of a microscope and that corrects distortions in the images and combines the images with one another is disclosed. In PTL 2, a composite image in which boundaries are almost invisible may be created. In PTL 3, an image combining apparatus that obtains a composite image desired by a user when the user specifies which of overlap regions whose images have been captured in an overlapped manner is to be selected, even if images in the overlap regions do not match is disclosed.

### CITATION LIST

### Patent Literature

PTL 1 Japanese Patent Laid-Open No. 2007-121837
PTL 2 Japanese Patent Laid-Open No. 2010-134374
PTL 3 Japanese Patent Laid-Open No. 2007-211837

Boundary portions of composite images obtained by the microscope system disclosed in PTL 1 and the image display system disclosed in PTL 2 are likely to be images different from ones observed by a pathologist using an optical microscope due to deviation in the positions of the partial images that inevitably occurs and the effects of artifacts caused by distortion correction or the like. If such composite images are diagnosed without recognizing the potential difficulty in making an accurate diagnosis, there is a problem in that it becomes difficult to make an accurate diagnosis when a boundary portion of the composite image is a target of the diagnosis. In addition, in the generation of a composite image disclosed in PTL 3, because the user performs the specification while taking a look at images of the overlap regions, the workload of the user for the specification becomes extremely large when a pathological image configured by hundreds to thousands of divided images, which is average image data, is a target. As a result, there is a problem in that it is difficult to combine the images in a practical period of time.

### SUMMARY OF INVENTION

The present invention relates to an image processing apparatus that generates image data regarding an imaging target to be displayed on the basis of pieces of data regarding divided images of the imaging target obtained by capturing an imaging range such that the pieces of data regarding divided images include overlap regions. The image processing apparatus includes an image data obtaining unit that obtains the plurality of pieces of data regarding divided images, an image data selection unit that automatically selects, for each of the overlap regions, a piece of image data to be displayed from the plurality of pieces of data regarding divided images on the basis of a predetermined condition, and a display control unit that displays, on an image display apparatus, each of the overlap regions using the piece of data regarding a divided image selected by the image data selection unit.

In addition, the present invention relates to an image display system. The image display system includes an image processing apparatus and an image display apparatus. The image processing apparatus is the above-described image processing apparatus. The image display apparatus selects and displays a divided image on the basis of image data regarding an imaging target transmitted from the image processing apparatus.

In addition, the present invention relates to a method for processing an image. The method includes an image data obtaining process for obtaining pieces of data regarding divided images of an imaging target obtained by capturing an imaging range such that the pieces of data regarding divided images include overlap regions, an image data selection process for automatically selecting, for each of the overlap regions, a piece of image data to be displayed from the plurality of pieces of data regarding divided images on the basis of a predetermined condition, and a display image data generation process for generating, in each of the overlap regions, image data regarding the imaging target using the piece of data regarding a divided image selected in the display image data selection process.

In addition, the present invention relates to a program for causing a computer to execute a process. The process includes an image data obtaining step of obtaining pieces of data regarding divided images of an imaging target obtained by capturing an imaging range such that the pieces of data regarding divided images include overlap regions, an image data selection step of automatically selecting, for each of the overlap regions, a piece of image data to be displayed from the plurality of pieces of data regarding divided images on the basis of a predetermined condition, and a display image data generation step of generating, in each of the overlap regions, image data regarding the imaging target using the piece of data regarding a divided image selected in the image data selection step.

Further features of the present invention will become apparent from the following description of exemplary embodiments with reference to the attached drawings.

### BRIEF DESCRIPTION OF DRAWINGS

FIG. 1 is a diagram illustrating the entirety of an example of the apparatus configuration of an image display system that uses an example of an image processing apparatus in the present invention.

FIG. 2 is an example of a functional block diagram illustrating an imaging apparatus in the image display system that uses the example of the image processing apparatus in the present invention.

FIG. 3 is an example of a functional block diagram illustrating an image processing apparatus according to a first embodiment.

FIG. 4 is an example of a hardware configuration diagram illustrating the image processing apparatus according to the first embodiment.

FIGS. 5A to 5C are diagrams illustrating the concept of specification of priority levels.

FIG. 6 is a diagram illustrating an example of a procedure for generating image data to be displayed according to the first embodiment.

FIG. 7 is a diagram illustrating an example of a procedure of priority display.

FIGS. 8A to 8E illustrate an example of a display screen according to the first embodiment.

FIGS. 9A to 9C are conceptual diagrams illustrating an example of a change of the display screen made by an instruction from the outside according to the first embodiment.

FIG. 10 is an example of a functional block diagram illustrating an image processing apparatus according to a second embodiment.

FIGS. 11A to 11D are diagrams illustrating the concept of automatic switching of the priority levels of images according to the second embodiment.

FIG. 12 is a diagram illustrating an example of a procedure for generating image data to be displayed according to the second embodiment.

FIG. 13 is a diagram illustrating an example of a procedure of priority display according to the second embodiment.

FIG. 14 is an example of a functional block diagram illustrating an image processing apparatus according to a third embodiment.

FIG. 15 is a diagram illustrating an example of a procedure for generating image data to be displayed according to the third embodiment.

FIG. 16 is a diagram illustrating the entirety of an example of an image display system that uses an example of the image processing apparatus according to the second embodiment.

### DESCRIPTION OF EMBODIMENTS

Embodiments of the present invention will be described hereinafter with reference to the drawings.

An image processing apparatus according to a preferred embodiment of the present invention generates image data regarding an imaging target on the basis of pieces of data regarding divided images of the imaging target captured while dividing an imaging range into a plurality of divided images including overlap regions. The image processing apparatus in the present invention has a characteristic that data regarding a composite image of the imaging target is generated without performing a process for combining the pieces of data regarding divided images when the data is to be displayed. Therefore, it is possible to prevent a problem that arises when the pieces of data regarding divided images are subjected to the combining process in order to generate the data regarding a composite image of the imaging target, that is, a problem in that the accuracy of a diagnosis decreases due to a composite portion different from an original image of the imaging target. In a region in which a plurality of pieces of data regarding divided images overlap, a piece of image data regarding the imaging target may be displayed by automatically selecting a divided image to be displayed. Accordingly, when a region displayed on a display includes a boundary between divided images, an image of the imaging target may be observed by changing the boundary.

The image processing apparatus according to the preferred embodiment of the present invention includes an image data obtaining unit that obtains a plurality of pieces of data regarding divided images, an image data selection unit that selects a piece of image data to be displayed from the plurality of pieces of data regarding divided images, and a display control unit that displays the selected piece of data regarding a divided image on a display unit.

The selection of a piece of image data by the image data selection unit may be realized on the basis of an automatic determination for the selection based on a predetermined condition or an instruction input from the outside. As the predetermined condition, a change in the position of a boundary between the pieces of data regarding divided images displayed on an image display apparatus or a change in the percentage of display of the pieces of data regarding divided images displayed on the image display apparatus may be used.

The image processing apparatus in the present invention may be used in a virtual slide system that uses pieces of data regarding divided images obtained by capturing images using a microscope.

An image display system in the present invention includes, in the image display system including an image processing apparatus and an image display apparatus, at least the above-described image processing apparatus and an image display apparatus that displays image data regarding an imaging target transmitted from the image processing apparatus.

In addition, a method for processing an image in the present invention includes an image data obtaining process for obtaining pieces of data regarding divided images of an imaging target captured while dividing an imaging range into a plurality of divided images including overlap regions, an image data selection process for automatically selecting, for each of the overlap regions, a piece of image data to be displayed from the plurality of pieces of data regarding divided images, and an image data selection process for generating, in each of the overlap regions, image data regarding the imaging target using the piece of data regarding a divided image selected in the display image data selection process.

In addition, a program in the present invention causes a computer to execute a process including an image data obtaining step of obtaining pieces of data regarding divided images of an imaging target captured while dividing an imaging range into a plurality of divided images including overlap regions, an image data selection step of automatically selecting, for each of the overlap regions, a piece of image data to be displayed from the plurality of pieces of data regarding divided images, and a display image data generation step of generating, in each of the overlap regions, image data regarding the imaging target using the piece of data regarding a divided image selected in the image data selection step.

In addition, a recording medium in the present invention relates to a computer-readable storage medium in which the above-described program is recorded.

The method for processing an image or the program in the present invention may reflect a preferable aspect described with respect to the image processing apparatus in the present invention.

### First Embodiment

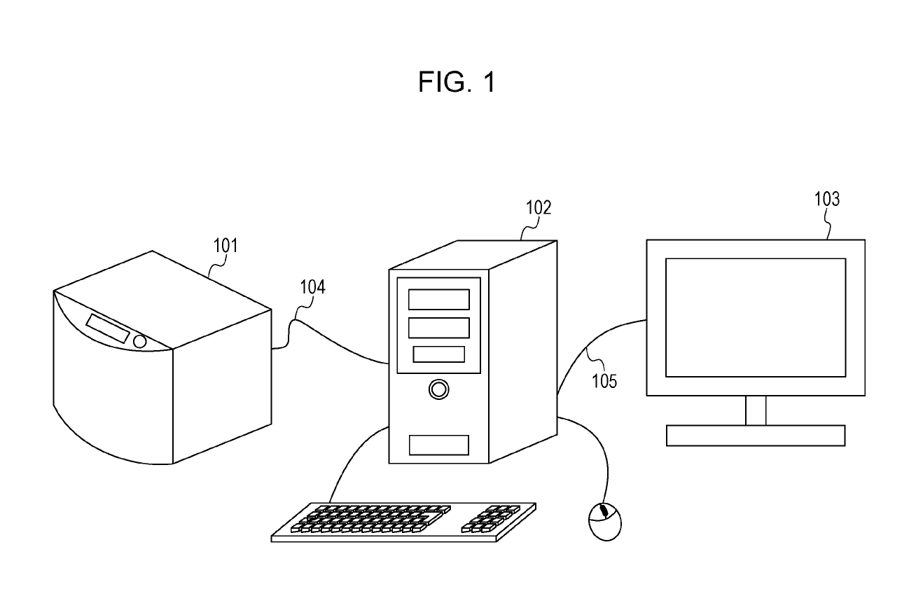

The image processing apparatus in the present invention may be used in an image display system that includes an imaging apparatus and an image display apparatus. The image display system will be described with reference to FIG. 1. It is to be noted that the “image display apparatus” may be simply referred to as the “display apparatus” in the following description and the accompanying drawings.

Configuration of Image Pickup System

FIG. 1 illustrates an image display system that uses the image processing apparatus in the present invention, that is configured by an imaging apparatus (microscope apparatus) 101, an image processing apparatus 102, and an image display apparatus 103, and that has a function of obtaining and displaying a two-dimensional image of an imaging target (test sample), whose image is to be captured. The imaging apparatus 101 and the image processing apparatus 102 are connected to each other by a dedicated or general-purpose I/F cable 104, and the image processing apparatus 102 and the image display apparatus 103 are connected to each other by a general-purpose I/F cable 105.

The imaging apparatus 101 captures a plurality of two-dimensional images whose positions are different in a two-dimensional direction, and may adopt a virtual slide apparatus having a function of outputting digital images. In order to obtain the two-dimensional images, a solid-state image pickup device such as a CCD (Charge Coupled Device) or a CMOS (Complementary Metal Oxide Semiconductor) sensor may be used. It is to be noted that the imaging apparatus 101 may be configured by a digital microscope apparatus obtained by mounting a digital camera on an eyepiece of a general optical microscope, instead of the virtual slide apparatus.

The image processing apparatus 102 is an apparatus having a function of, for example, generating data regarding a composite image using data regarding an original image obtained, in a divided manner, from a plurality of pieces of data regarding original images obtained from the imaging apparatus 101. The image processing apparatus 102 is configured by a general-purpose computer or a workstation including hardware materials such as a CPU (central processing unit), a RAM, a storage device, an operation unit, and an I/F. The storage device is a large-capacity information storage device such as a hard disk drive, and stores a program, data, an OS (operating system), and the like for realizing processes that will be described later. The above-described functions are realized by the CPU by loading a necessary program and data from the storage device into the RAM and by executing the program. The operation unit is configured by a keyboard, a mouse, and the like, and used by an operator to input various instructions. The image display apparatus 103 is a monitor that displays an image to be observed, which is a result of arithmetic processing performed by the image processing apparatus 102, and is configured by a CRT, a liquid crystal display, or the like.

Although the image pickup system is configured by the three apparatuses, namely the imaging apparatus 101, the image processing apparatus 102, and the image display apparatus 103, in the example illustrated in FIG. 1, the configuration in the present invention is not limited to this configuration. For example, an image processing apparatus into which the image display apparatus is incorporated may be used, or the function of the image processing apparatus may be integrated with the imaging apparatus. Alternatively, the functions of the imaging apparatus, the image processing apparatus, and the image display apparatus may be realized by a single apparatus. On the other hand, the function of the image processing apparatus or the like may be divided and realized by a plurality of apparatuses.

Configuration of Imaging Apparatus

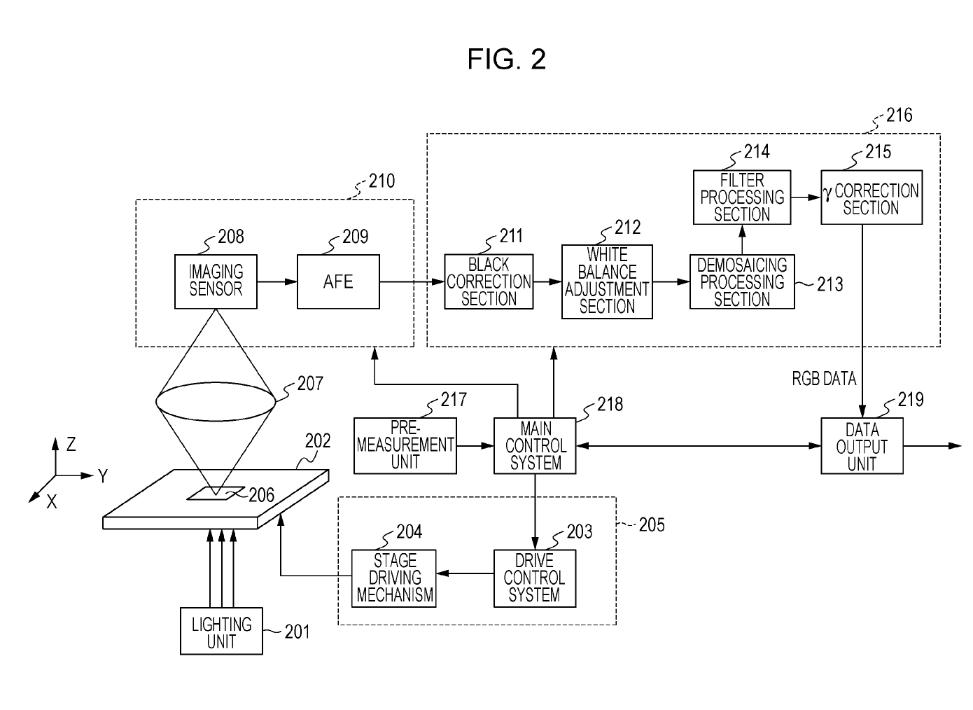

FIG. 2 is a block diagram illustrating the functional configuration of the imaging apparatus 101.

The imaging apparatus 101 is schematically configured by a lighting unit 201, a stage 202, a stage control unit 205, an image forming optical system 207, an image pickup unit 210, a development process unit 216, a pre-measurement unit 217, a main control system 218, and a data output unit 219.

The lighting unit 201 is means for evenly radiating light onto a prepared slide 206 disposed on the stage 202, and configured by a light source, a lighting optical system, and a control system for driving the light source. The stage 202 is subjected to drive control performed by the stage control unit 205, and may move along three axes, namely x, y, and z axes. The prepared slide 206 is a member in which a tissue or an applied cell to be observed is attached on a slide glass and fixed under a cover glass along with a mounting agent.

The stage control unit 205 is configured by a drive control system 203 and a stage driving mechanism 204. The drive control system 203 performs the drive control on the stage 202 upon receiving an instruction from the main control system 218. The movement direction and the amount of movement of the stage 202 and the like are determined on the basis of positional information and thickness information (distance information) regarding an imaging target measured by the pre-measurement unit 217 and, as necessary, on the basis of an instruction from a user. The stage driving mechanism 204 drives the stage 202 in accordance with an instruction from the drive control system 203.

The image forming optical system 207 is a group of lenses for forming an optical image of the imaging target on the prepared slide 206 on an image pickup sensor 208.

The image pickup unit 210 is configured by the image pickup sensor 208 and an analog front end (AFE) 209. The image pickup sensor 208 is a one-dimensional or two-dimensional image sensor that converts a two-dimensional optical image into an electrical physical quantity through photoelectric conversion, and, for example, a CCD or a CMOS device is used therefor. In the case of a one-dimensional sensor, a two-dimensional image is obtained by scanning in a scanning direction. The image pickup sensor 208 outputs an electrical signal having a value of voltage according to the intensity of light. When a color image is desired as a captured image, for example, a single-chip image sensor mounted with a color filter having a Bayer pattern may be used. The image pickup unit 210 captures divided images of the imaging target while the stage 202 is being driven along the x and y axes.

The AFE 209 is a circuit that converts an analog signal output from the image pickup sensor 208 into a digital signal. The AFE 209 is configured by an H/V driver, a CDS (Correlated Double Sampler), an amplifier, an A/D converter, and a timing generator, which will be described hereinafter. The H/V driver converts a vertical synchronization signal and a horizontal synchronization signal for driving the sensor into a potential necessary for driving the image pickup sensor 208. The CDS is a correlated double sampling circuit that removes fixed pattern noise. The amplifier is an analog amplifier that adjusts gain of an analog signal from which noise has been removed by the CDS. The A/D converter converts the analog signal into a digital signal. When an output of a final stage of the imaging apparatus is to be 8 bits, the A/D converter converts, in consideration of processing in later stages, a 10-bit analog signal into digital data quantized to about 16 bits, and outputs the digital data. Converted data output from the sensor is called RAW data. The RAW data is subjected to a development process by the development process unit 216 in a later stage. The timing generator generates a signal for adjusting the timing of the image pickup sensor 208 and the timing of the development process unit 216 in the later stage.

When a CCD is used as the image pickup sensor 208, the AFE 209 is essential, but when a CMOS image sensor capable of digital output is used, the function of the AFE 209 is included in the sensor. In addition, although not illustrated, an image pickup control unit that controls the image pickup sensor 208 exists, and collectively controls the operation of the image pickup sensor 208 and the operation timing such as shutter speed, a frame rate, and an ROI (Region Of Interest).

The development process unit 216 is configured by a black correction section 211, a white balance adjustment section 212, a demosaicing processing section 213, a filter processing section 214, and a γ correction section 215. The black correction section 211 performs a process for subtracting black correction data obtained while light is blocked from each pixel of the RAW data. The white balance adjustment section 212 performs a process for reproducing a desired white color by adjusting gain of each of R, G, and B in accordance with the color temperature of the light radiated from the lighting unit 201. More specifically, data for white balance correction is added to the RAW data after the black correction. The process for adjusting the white balance is not necessary when a monochrome image is used. The development process unit 216 generates data regarding divided images of an imaging target captured by the image pickup unit 210.

The demosaicing processing section 213 performs a process for generating image data regarding each of R, G, and B from the RAW data having a Bayer pattern. The demosaicing processing section 213 calculate the value of each of R, G, and B of a target pixel by interpolating the values of nearby pixels (include pixels of the same color and pixels of different colors) in the RAW data. In addition, the demosaicing processing section 213 executes a process (interpolation process) for correcting defective pixels. It is to be noted when the image pickup sensor 208 does not include a color filter and a monochrome image is obtained, the demosaicing process is not necessary.

The filter processing section 214 is a digital filter that realizes suppression of high-frequency components included in an image, removal of noise, and enhancement of resolution. The γ correction section 215 executes, in accordance with the tone expression characteristics of a general display device, a process for adding opposite characteristics and tone conversion according to the visual characteristics of humans using tone compression in a bright portion and dark space processing. In the present embodiment, tone conversion that suits a combining process and a display process in later stages is applied to the image data in order to obtain an image meant for a shape observation. The process for converting the tone performed by the γ correction section 215 may be configured to be performed in the image processing apparatus 102, which will be described later, instead.

The pre-measurement unit 217 is a unit that performs preliminary measurement for calculating information regarding the position of an imaging target on the prepared slide 206, information regarding a distance to a desired focal position, and a parameter for adjusting the amount of light in accordance with the thickness of the imaging target. By obtaining the information by the pre-measurement unit 217 prior to main measurement, an image may be captured without waste. In order to obtain the information regarding a position in a two-dimensional plane, a two-dimensional image pickup sensor whose resolution is lower than that of the image pickup sensor 208 is used. The pre-measurement unit 217 detects the position of the imaging target in an xy plane from the obtained image. A laser displacement meter or a Shack-Hartmann measuring instrument is used to obtain the distance information and the thickness information.

The main control system 218 provides a function of controlling the units described above. The functions of the main control system 218 and the development process unit 216 are realized by a control circuit including a CPU, a ROM, and a RAM. That is, a program and data are stored in the ROM, and the CPU executes the program while using the RAM as a working memory, in order to realize the functions of the main control system 218 and the development process unit 216. A device such as, for example, an EEPROM or a flash memory is used as the ROM, and a DRAM device such as, for example, DDR3 is used as the RAM.

The data output unit 219 is an interface for transmitting an RGB color image generated by the development process unit 216 to the image processing apparatus 102. The imaging apparatus 101 and the image processing apparatus 102 are connected to each other by an optical communication cable. Alternatively, a general-purpose interface such as USB or Gigabit Ethernet (registered trademark) is used.

Configuration of Image Processing Apparatus

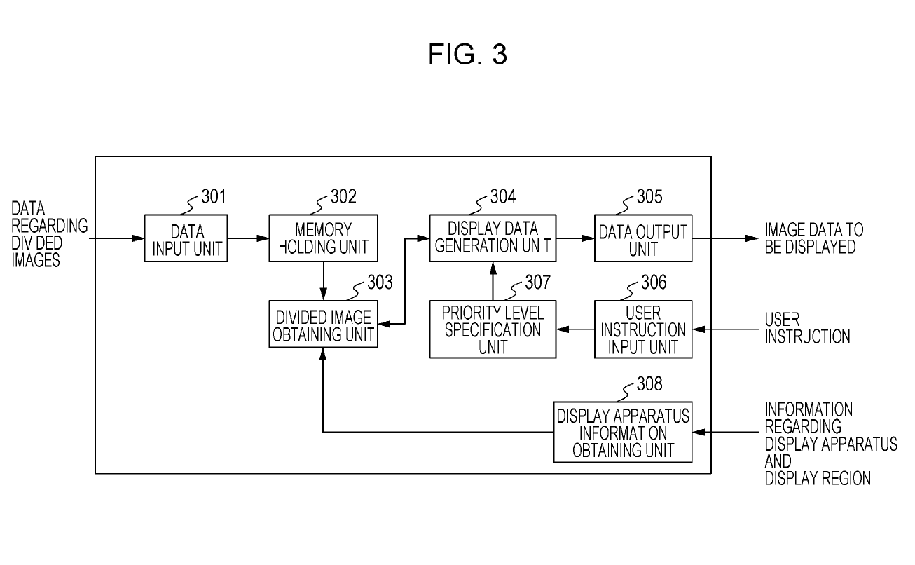

FIG. 3 is a block diagram illustrating the functional configuration of the image processing apparatus 102 in the present invention.

The image processing apparatus 102 is schematically configured by a data input unit 301, a memory holding unit 302, a divided image data obtaining unit 303, a display data generation unit 304, a data output unit 305, a user instruction input unit 306, a priority level specification unit 307 for boundary regions, and a display apparatus information obtaining unit 308.

The memory holding unit 302 stores or holds data regarding divided RGB color images obtained from an external apparatus through the data input unit 301 by dividing an image of the imaging target and by capturing the divided images. The data regarding color images includes not only image data but also positional information. Here, the positional information is information indicating a portion of the imaging target whose image has been captured as data regarding a divided image. For example, the positional information may be obtained by recording x and y coordinates at the time of driving of the stage 202 along with the data regarding a divided image while the image is being captured.

The divided image data obtaining unit 303 obtains the data regarding divided images stored in or held by the memory holding unit 302 on the basis of information regarding an image display apparatus and the size of a display region obtained from the display apparatus information obtaining unit 308 and control information obtained from the display data generation unit 304. In addition, the divided image data obtaining unit 303 transmits the obtained data regarding divided images to the display data generation unit 304.

The user instruction input unit 306 receives instructions by the user as to image data to be displayed that is to be generated, which will be described later, and instructions to update the image data to be displayed such as a change and enlargement of the display position and reduced display through an operation input unit such as a mouse or a keyboard. The priority level specification unit 307 specifies which piece of data regarding a divided image is to be used as image data to be displayed for a region in which pieces of data regarding divided images overlap on the basis of the information received by the user instruction input unit 306. The priority level specification unit 307 may also serve as a switching unit that switches data to be displayed in an overlap region between image data regarding the imaging target generated by selecting a piece of image data to be displayed from the plurality of pieces of data regarding divided images and data regarding a composite image of the imaging target generated by combining a plurality of divided images.

The display data generation unit 304 generates display data from the data regarding divided images transmitted from the divided image data obtaining unit 303 on the basis of priority levels specified by the priority level specification unit 307. The generated display data is output to an external monitor or the like through the data output unit 305 as image data to be displayed.

Hardware Configuration of Image Processing Apparatus

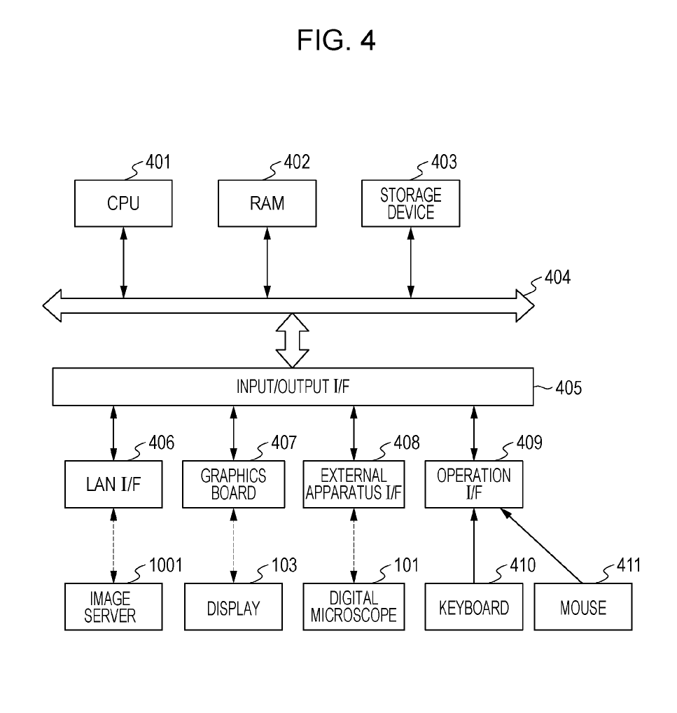

FIG. 4 is a block diagram illustrating the hardware configuration of the image processing apparatus in the present invention. As an apparatus that performs information processing, for example, a PC (Personal Computer) is used.

The PC includes a CPU (Central Processing Unit) 401, a RAM (Random Access Memory) 402, a storage device 403, a data input/output I/F 405, and an internal bus 404 that connects these components to one another.

The CPU 401 accesses the RAM 402 or the like as necessary, and collectively controls the entirety of each block of the PC while performing various types of arithmetic processing. The RAM 402 is used as a work area of the CPU 401 or the like, and temporarily holds an OS, various programs that are being executed, and various pieces of data to be subjected to processes such as user identification using an annotation and generation of data to be displayed, which are characteristic of the present invention. The storage device 403 is an auxiliary storage device that records and reads information stored in a fixed manner regarding firmware such as an OS, programs, and various parameters to be executed by the CPU 401. A magnetic disk drive such as an HDD (Hard Disk Drive) or an SSD (Solid State Disk) or a semiconductor device that uses a flash memory may be used.

To the data input/output I/F 405, an image server 1001 is connected through a LAN I/F 406, the image display apparatus 103 is connected through a graphics board 407, the imaging apparatus 101 typified by a virtual slide apparatus and a digital microscope is connected through an external apparatus I/F 408, and a keyboard 410 and a mouse 411 are connected through an operation I/F 409.

The image display apparatus 103 is a display device that uses, for example, a liquid crystal, EL (electroluminescence), a CRT (Cathode Ray Tube), or the like. The image display apparatus 103 is assumed to be connected as an external apparatus, but a PC incorporated into an image display apparatus may be assumed. A notebook PC is an example of this.

Although a pointing device such as the keyboard 410 or the mouse 411 is assumed as a device connected to the operation I/F 409, a configuration may be adopted in which a screen of the image display apparatus 103 directly serves as an input device such as in the case of a touch panel. In this case, the touch panel may be incorporated into the image display apparatus 103.

Specification of Priority Levels of Images

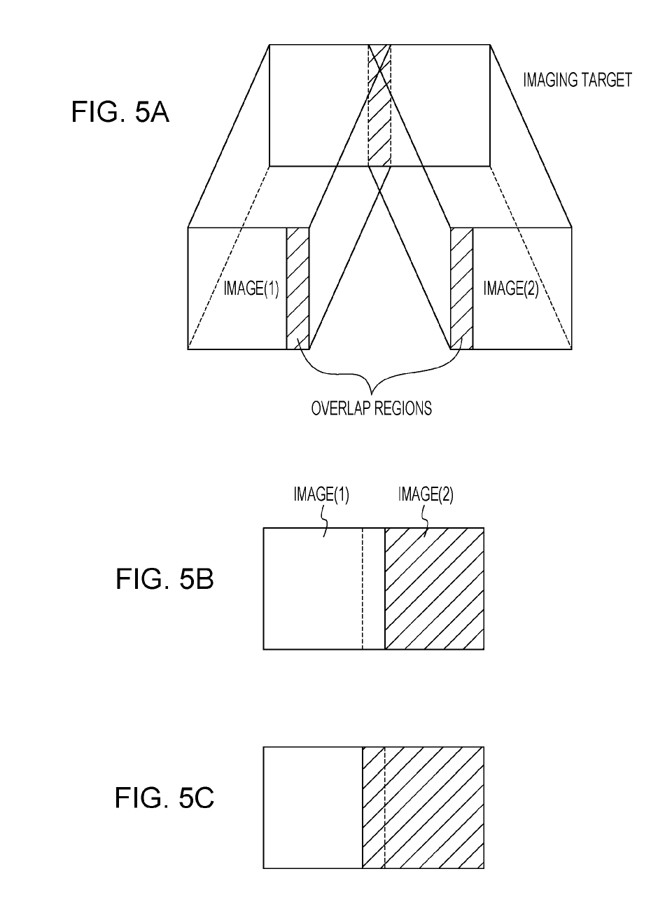

The concept of specification of the priority levels in displaying an overlap region between pieces of data regarding divided images performed by the image processing apparatus in the present invention will be described with reference to FIGS. 5A to 5C.

FIG. 5A illustrates obtaining of divided images. An upper part of FIG. 5A illustrates an imaging target, and in a lower part of FIG. 5A, an image of the imaging target is captured while dividing the imaging target into two regions, namely an image (1) and an image (2), including overlap regions, and data regarding divided images is obtained.

FIG. 5B illustrates an example of displaying a captured overlap region while selecting the image (1) from the two pieces of data regarding divided images. In this case, the priority level of the image (1) in displaying the overlap region is set high.

FIG. 5C illustrates an example of displaying image data while selecting the image (2), and the priority level of the image (2) in display is set high.

As described above, a composite image to be displayed may be generated by setting the priority level of one of adjacent pieces of data regarding divided images in displaying the overlap region to be higher in order to select the one of the adjacent pieces of data as a region to be displayed.

In the case of the image processing apparatus 102 in the present invention, image data to be displayed may be displayed on the image display apparatus 103 by selecting the image data in accordance with a predetermined condition or an instruction from the user.

Generation of Image Data

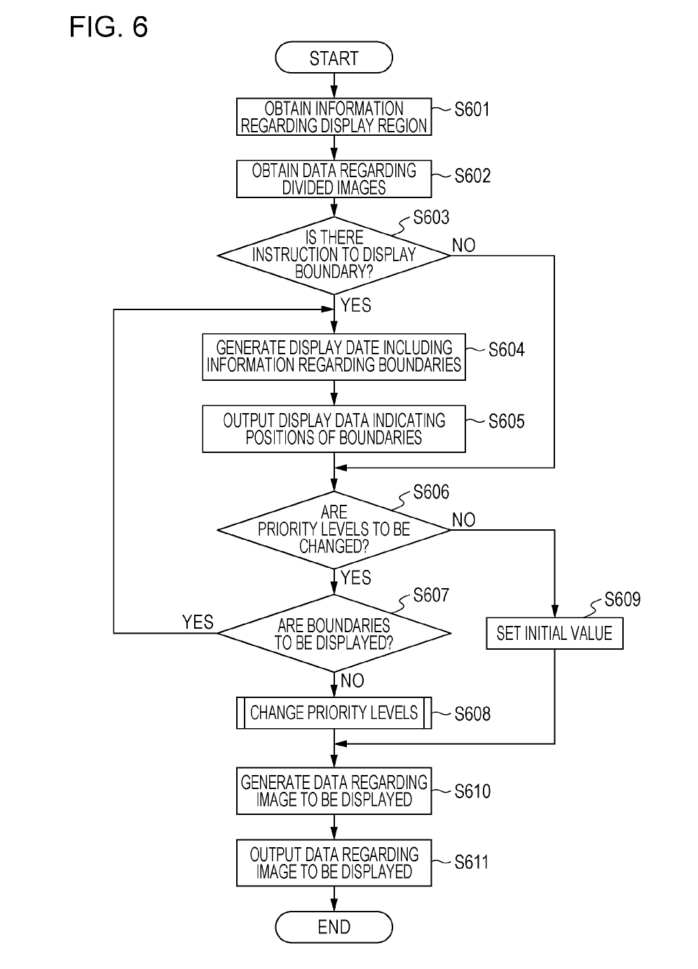

A procedure for generating image data performed by the image processing apparatus in the present invention will be described with reference to a flowchart of FIG. 6.

In step 601, when image data is to be displayed on the image display apparatus 103, information regarding a display region such as the resolution of a monitor, which is the image display apparatus 103 connected to the image processing apparatus 102, a display position in the entirety of an image of an imaging target, and display magnification is obtained.

In step 602, the divided image data obtaining unit 303 obtains a necessary number of pieces of data regarding divided images from pieces of data regarding divided images received by the data input unit 301 and stored in the memory holding unit 302. When pieces of data regarding divided images at different magnifications are hierarchically stored or held, pieces of data regarding divided images at an appropriate level are selected on the basis of the information regarding the display magnification obtained in step 601.

Image data obtained by the imaging apparatus 101 is desirably high-resolution, high-resolving power image pickup data in order to enable a diagnosis. However, as described above, when a reduced image of image data composed of billions of pixels is to be displayed, processing becomes cumbersome if resolution conversion is performed each time the setting of display is changed. Therefore, it is desirable that hierarchical images at some levels whose magnifications are different are prepared and image data at a magnification close to the display magnification is selected from the prepared hierarchical images in accordance with a request from a display side, in order to adjust the magnification in accordance with the display magnification. In general, display data is preferably generated from image data at a higher magnification for the sake of image quality.

Because images are captured at high resolution, hierarchical image data to be displayed is generated by reducing image data at highest resolution using a method for converting the resolution. As methods for converting the resolution, a bilinear method, which is a two-dimensional linear interpolation process, a bicubic method, which uses a cubic interpolation expression, and the like are widely known.

In step 603, whether or not to display boundaries between the pieces of data regarding divided images is determined. In the present invention, in which a composite image is not prepared in advance but pieces of data regarding divided images to be displayed are selected each time, it is desirable to assume that the boundaries are displayed and, if not, a configuration is adopted in which the user selects whether or not to display the boundaries.

If the boundaries are not to be displayed, the procedure proceeds to step 606. If the boundaries between the pieces of data regarding divided images are to be displayed, the procedure proceeds to step 604.

In step 604, the display data generation unit 304 generates image data including information regarding the positions of the boundaries. More specifically, the information is generated by superimposing boundary position display data indicating the boundaries between the adjacent images using lines and regions upon image data in normal display. At this time, the boundary position display data takes priority over the image data to be displayed in display. It is to be noted that which of the pieces of data regarding divided images takes priority in display in an initial state may be determined in accordance with a predetermined rule. For example, when four divided images are used, for example, right may take priority over left, upper may take priority over lower, and upper left may take priority over lower right. When a plurality of pieces of data regarding divided images are used, numbers may be provided from a right end to the left and then from a right end in a next row (a row immediately below the row for which the numbers have been provided), and younger numbers may have higher priority. Such provision of numbers may be performed on the basis of the user's preference. For example, numbers may be provided such that the priority level of a piece of data regarding a divided image including the position of the beginning of an observation made by a particular user becomes the highest. Other examples of the priority determination rule include a rule that the priority level of a piece of data regarding a divided image including the center of a displayed image becomes the highest and a rule that when an image in the initial state is asymmetrical, the priority level of a piece of data regarding a divided image that occupies a largest part of the overall image becomes the highest.

In step 605, the image data generated in step 604 is output to the image display apparatus 103. The output image data to be displayed is displayed on the image display apparatus 103. When the displayed image data has been changed by an instruction from the user after the display, such as scrolling of a screen, processing and determinations in the following steps are performed.

In step 606, for a plurality of overlap regions between the pieces of data regarding divided images, whether or not to switch selection of pieces of data regarding divided images to be displayed on the image display apparatus 103, that is, whether or not to change the priority levels of the images to be displayed on the image display apparatus 103, is determined. If the priority levels are not to be changed, the procedure proceeds to step 609. If the priority levels are to be changed, the procedure proceeds to step 607.

In step 607, whether or not there has been an instruction to display the boundaries is determined. If there has been an instruction to display the boundaries, the procedure returns to step 604. If there has been no instruction to display the boundaries, the procedure proceeds to step 608. It is to be noted that this processing step is used to indicate the positions of the boundaries in order to enable the user to issue an instruction to change the priority levels when there has been no instruction to display the boundaries in step 603 and the priority levels have been changed in step 606.

In step 608, for the plurality of overlap regions between the pieces of data regarding divided images, the selection of the pieces of data regarding divided images to be displayed on the image display apparatus 103 is changed. That is, in this step, the priority levels in displaying the overlap regions on the image display apparatus 103 are changed. Details of the change of the priority levels will be described later with reference to another flowchart.

In step 609, since there is no instruction as to the priority levels, a predetermined initial value is set as the priority levels. The predetermined setting value is selected while there is no instruction to display the boundaries and no instruction to change the priority levels from the user. For example, a piece of data regarding a divided image located at the left may take priority over one located at the right, and a piece of data regarding a divided image located higher may take priority over one located lower.

In step 610, image data to be displayed on the image display apparatus 103 is generated on the basis of the priority levels determined in step 608 or in step 609.

In step 611, the image data to be displayed on the image display apparatus 103 generated in step 610 is transmitted to the image display apparatus 103 or the like through the data output unit 305.

Change of Priority Levels

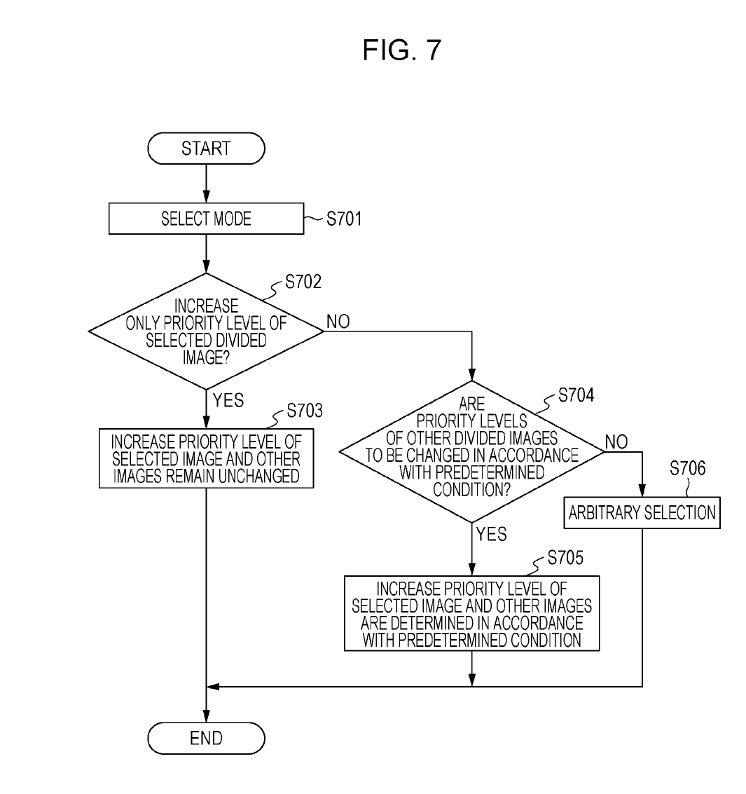

The change of the priority levels illustrated by step 608 in FIG. 6 will be described with reference to a flowchart of FIG. 7.

In step 701, a display mode, which is a method for selecting image data to be displayed on the image display apparatus 103, is selected for plurality of overlap regions between the pieces of data regarding divided images. Here, three modes are basically assumed, namely, a mode in which only the priority level of a piece of data regarding a divided image selected by the user increases, a mode in which the priority level of a selected piece of data regarding a divided image increases and the priority levels of other pieces of data regarding divided images are determined according to a set condition, and a mode in which the priority level of a selected piece of data regarding a divided image increases and the priority level of other pieces of data regarding divided images may be arbitrarily determined.

In step 702, whether or not to select the mode in which only the priority level of a selected piece of data regarding a divided image increases is determined. If another display mode is selected, a display condition is further determined in step 704. If only the priority level of a selected piece of data regarding a divided image is to be increased, the procedure proceeds to step 703.

In step 703, only the priority level of a selected piece of data regarding a divided image increases, and the priority levels of other divided images remain unchanged, in order to determine the priority levels for the overlap regions. For example, when an arbitrary piece of data regarding a divided image has been selected, all of four overlap regions existing between four vertically and horizontally adjacent pieces of image data are displayed using the selected piece of data regarding a divided image.

In step 704, the priority level of the selected piece of data regarding a divided image increases, and then whether or not to change the priority levels of images other than the selected piece of data regarding a divided image in accordance with the predetermined condition is determined. If the priority of the images other than the selected piece of data regarding a divided image is to be arbitrarily set, the procedure proceeds to step 705, and if the priority levels of the images other than the selected piece of data regarding a divided image are to be changed in accordance with the predetermined condition, the procedure proceeds to step 706.

In step 705, the priority level of the selected piece of data regarding a divided image increases, and the priority levels are determined such that the image is displayed while determining the priority levels for the overlap regions other than that of the selected piece of data regarding a divided image in accordance with the predetermined condition.

In step 706, the priority level of the selected piece of data regarding a divided image increases, and the priority levels are determined such that the image is displayed while arbitrarily selecting the priority level for the overlap regions other than that of the selected piece of data regarding a divided image. Here, arbitrarily selecting the priority levels for the overlap regions other than that of the selected piece of image data refers to, when the image is displayed using four pieces of data regarding divided images, determining the priority level of each of remaining second and third pieces of data regarding divided images. The priority level of a fourth piece of data inevitably becomes the lowest.

Layout of Display Screen

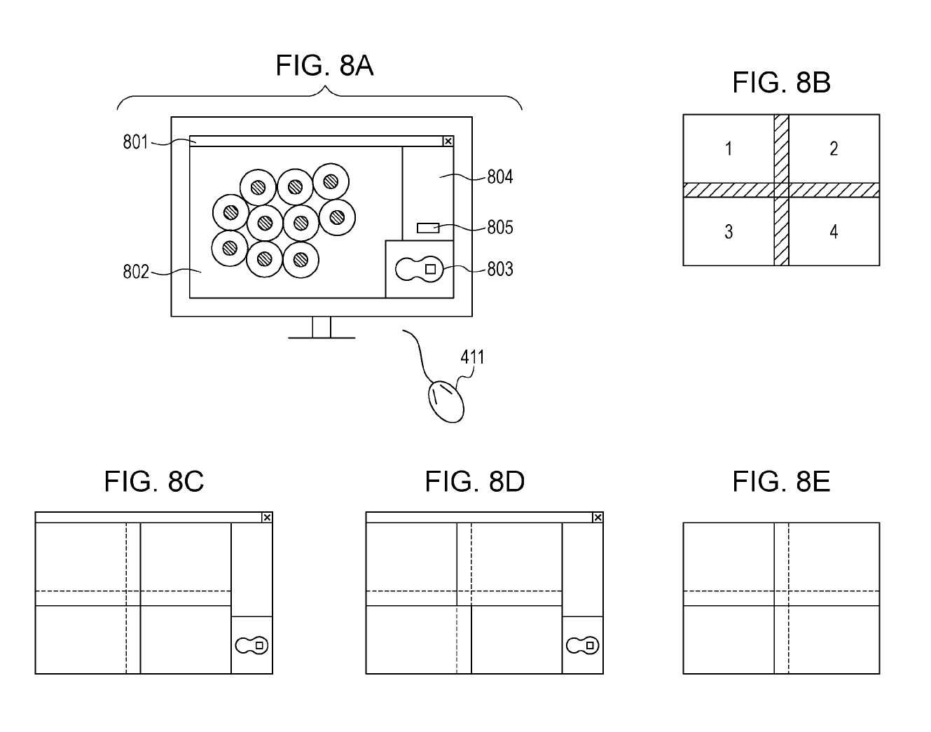

FIGS. 8A to 8E are diagrams illustrating an example of displaying image data generated by the image processing apparatus 102 in the present invention on the image display apparatus 103. FIG. 8A illustrates a layout of a display screen of the image display apparatus 103. In the display screen, a display region 802 of image data regarding an imaging target to be observed in detail, a thumbnail image 803 of the object to be observed, and a region 804 of display setting are displayed inside an overall window 801. The display region 802 of the image of the imaging target and the thumbnail image 803 of the object to be observed may be displayed while dividing the display region of the overall window 801 into functional regions using a single document interface or may be displayed while configuring each region by an individual window using a multiple document interface. The image data regarding the imaging target to be observed in detail is displayed in the display region 802 of the image data regarding the imaging target. Here, the display region is moved or an image enlarged or reduced by changing the display magnification is displayed in accordance with an operation instruction from the user. The thumbnail image 803 indicates the position and the size of the image data regarding the imaging target in the display region 802 relative to an overall image of the imaging target. In the region 804 of the display setting, for example, the display setting may be changed by selecting and pressing a setting button 805 in accordance with a user instruction from the touch panel or an input device connected from the outside, such as the mouse 411. Although the setting button 805 is arranged in the region 804 of the display setting, instructions as to selection and setting may be realized by selecting and specifying corresponding items in a menu screen, instead.

FIG. 8B is a conceptual diagram illustrating image data regarding an imaging target configured by a plurality of pieces of data regarding divided images. In FIG. 8B, the image data regarding the imaging target is configured by four pieces of data regarding divided images including overlap regions. The four pieces of image data will be referred to as images (1) to (4) for convenience of description. These pieces of image data include the overlap regions indicated by hatching.

FIG. 8C is a schematic diagram illustrating a display screen in which the image (1) has been selected by an instruction to change the priority levels input from the outside. In FIG. 8C, the priority level of the image (1) in display is the highest, and therefore the image of the imaging target is displayed while using the piece of data regarding the divided image of the image (1) in the overlap region between the image (1) and the image (2), the overlap region between the image (1) and (3), and the overlap region between the image (1) and the image (4). The priority levels of the image (2) and the image (3) in display are the second highest after the priority level of the image (1), and therefore the image of the imaging target is displayed while using the piece of data regarding the image (2) in the overlap region between the image (2) and the image (4) and the piece of data regarding the image (3) in the overlap region between the image (3) and the image (4). The image (4) is not used for displaying the overlap regions. It is to be noted that the mode in which only the priority level of a selected piece of data regarding a divided image is changed is assumed to have been selected in the following description.

FIG. 8D is a schematic diagram illustrating a display screen in which the image (2) has been selected after FIG. 8C is displayed. In FIG. 8D, the image (2), the image (1), the image (3), and the image (4) are displayed in this order as the overlapping images, in order to create the image data regarding the imaging target.

FIG. 8E is a schematic diagram illustrating a display screen different from that illustrated in FIG. 8C in which the image (2) has been selected after FIG. 8C is displayed. In FIG. 8E, the priority level of the image (2) in display is the highest, the priority levels of the image (1) and the image (4) in display are the second highest, and the image (3) is not used for displaying the overlap regions. A difference between FIG. 8D and FIG. 8E is whether or not boundary regions match and therefore boundaries are displayed as a line.

When the image (2) has been selected after FIG. 8C is displayed, FIG. 8D or FIG. 8E is selected in accordance with a preselected mode or an instruction input from the outside.

Changes of Display in Accordance with Instructions from Outside

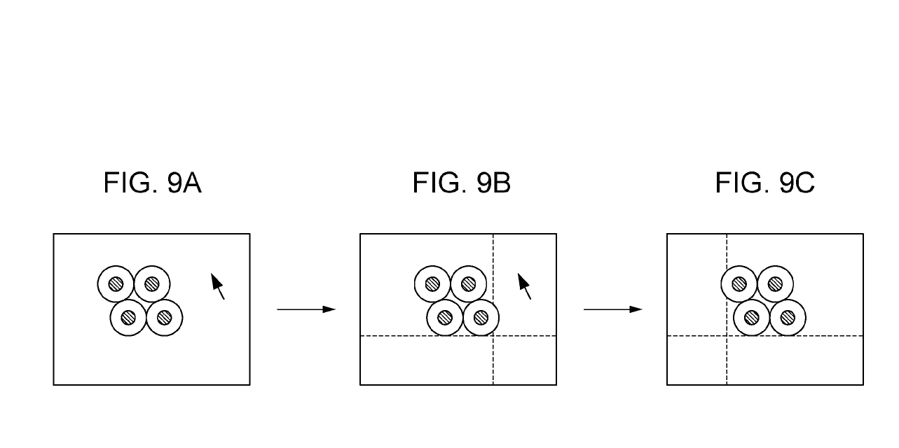

FIGS. 9A to 9C are conceptual diagrams illustrating changes of display of the display screen in accordance with instructions from the outside. FIG. 9A illustrates an image of an imaging target displayed in the display region 802. As illustrated in FIG. 9B, boundaries between divided images in the image are displayed in a grid in accordance with an instruction from an external input device such as, for example, the keyboard 410 or the mouse 411. The display is realized as a result of the processing in step 605 described above. In FIG. 9B, the image of the imaging target is displayed while displaying the overlap regions using the four pieces of data regarding divided images illustrated in FIG. 8C for which the priority is provided.

FIG. 9C illustrates a change of the display screen at a time when an upper right region of the image of the imaging target has been selected using the keyboard 410, the mouse 411, or the like in FIG. 9B. Although the divided images are displayed using the priority illustrated in FIG. 8C, the display screen is changed to the screen illustrated in FIG. 9C corresponding to FIG. 8D or FIG. 8C when a portion of FIG. 8C in which the image (2) is displayed has been selected. The image after the change is determined by an instruction from the keyboard 410 or the mouse 411. Alternatively, the image may be determined when the initial selection is made. It is to be noted that grid lines indicating the boundaries between the pieces of data regarding divided images are also updated in accordance with the change in priority levels.

In the present embodiment, an unintended diagnosis based on the positions of boundaries and regions in a composite image different from an original image may be prevented by displaying pieces of data regarding divided images while switching the pieces of data regarding divided images in accordance with an instruction from the user.

### Second Embodiment

An image display system according to a second embodiment of the present invention will be described with reference to the drawings.

In the first embodiment, image data regarding an imaging target to be displayed is generated by selecting, in accordance with a user instruction from the outside, a piece of data regarding a divided image used for displaying an overlap region from pieces of data regarding divided images captured while dividing an imaging range into a plurality of divided images including overlap regions. In the second embodiment, image data regarding an imaging target to be displayed is generated by selecting pieces of data regarding divided images captured while dividing an imaging range into a plurality of divided images including overlap regions on the basis of predetermined priority levels of display of the overlap regions. Therefore, in the second embodiment, the data regarding an imaging target to be displayed is generated by automatically selecting a piece of data regarding a divided image to be displayed in accordance with the position of a boundary between pieces of data regarding divided images in a displayed image.

In the second embodiment, the same configurations as those described in the first embodiment may be used except for configurations different from those according to the first embodiment.

Configuration of Image Display System

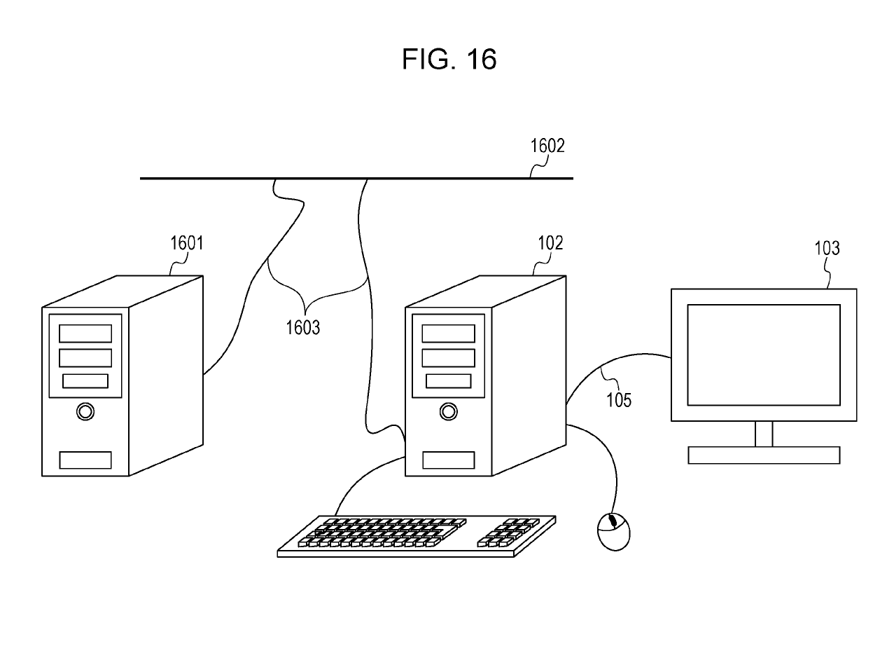

FIG. 16 is a diagram illustrating the entirety of the apparatus configuration of the image display system according to the second embodiment of the present invention.

In FIG. 16, the image display system that uses the image processing apparatus in the present invention is configured by an image server 1601, an image processing apparatus 102, and an image display apparatus 103. The image processing apparatus 102 may obtain data regarding divided images of an imaging target from the image server 1601, and generate image data to be displayed on the image display apparatus 103. The image server 1601 and the image processing apparatus 102 are connected to each other by a general-purpose I/F LAN cable 1603 through a network 1602. The image server 1601 is a computer including a large-capacity storage device that saves data regarding divided images captured by the imaging apparatus 101, which is a virtual slide apparatus. The image server 1601 may save, as a group of images, divided images to a local storage connected thereto, or may divide the data regarding divided images and hold the pieces of data regarding divided images themselves and link information separately from each other in a group of servers (cloud servers) existing somewhere in the network. The data regarding divided images need not be saved to a single server. It is to be noted that the image processing apparatus 102 and the image display apparatus 103 are the same as those in the image pickup system according to the first embodiment.

Although the image display system is configured by the three apparatuses, namely the image server 1601, the image processing apparatus 102, and the image display apparatus 103, in the example illustrated in FIG. 16, the present invention is not limited to this configuration. For example, an image processing apparatus into which an image display apparatus is incorporated may be used, or a part of the function of the image processing apparatus 102 may be integrated with the image server 1601. Alternatively, the functions of the image server 1601 and the image processing apparatus 102 may be divided and realized by a plurality of apparatuses.

Configuration of Image Processing Apparatus

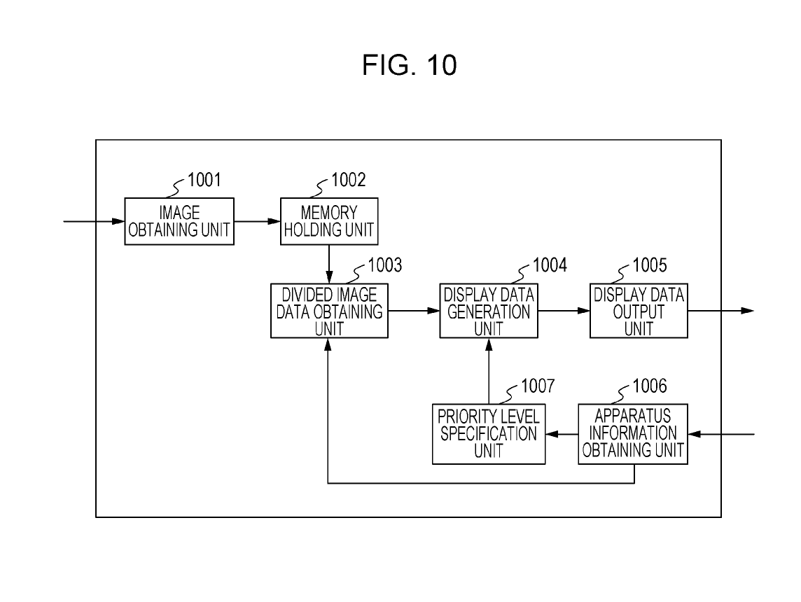

FIG. 10 is a block diagram illustrating the functional configuration of the image processing apparatus 102 in the present invention.

The image processing apparatus 102 is schematically configured by a data input unit 1001, a memory holding unit 1002, a divided image data obtaining unit 1003, a display data generation unit 1004, a display data output unit 1005, a display apparatus information obtaining unit 1006, and a priority level specification unit 1007.

The memory holding unit 1002 stores or holds data regarding divided RGB color images obtained from the image server 1601, which is an external apparatus, through the data input unit 1001 by dividing an image of the imaging target and by capturing the divided images. The data regarding color images includes not only image data but also positional information. Here, the positional information is information indicating a portion of the imaging target whose image has been captured as data regarding a divided image. For example, the positional information may be obtained by recording x and y coordinates at the time of driving of the stage 202 along with the data regarding a divided image while the image is being captured.

The divided image data obtaining unit 1003 obtains the data regarding divided images stored in or held by the memory holding unit 1002 and information regarding an image display apparatus and data such as a display region from the display apparatus information obtaining unit 1006. In addition, the divided image data obtaining unit 1003 transmits the obtained data regarding divided images including the positional information to the display data generation unit 1004.

The priority level specification unit 1007 selects, for a region in which pieces of data regarding divided images overlap, which piece of data regarding a divided image is to be used on the basis of the information transmitted from the display apparatus information obtaining unit and predetermined information. The information obtained from the image display apparatus 103 is values indicating movement (screen scrolling) of the display screen and the state of enlarged or reduced display, which is a change in the display magnification, according to user instructions. The priority level specification unit 1007 calculates a change in the position of a boundary between pieces of data regarding divided images from this information, and switches the priority level in displaying the overlap region between the pieces of data regarding divided images using a predetermined procedure or method on the basis of an updated position of the boundary in the display screen, which is a result of the calculation.

The display data generation unit 1004 generates display data from the data regarding divided images transmitted from the divided image data obtaining unit 1003 on the basis of the priority levels specified by the priority level specification unit 1007. The generated display data is output to an external monitor or the like through the data output unit 1005 as image data to be displayed.

Automatic Switching of Priority Levels of Images

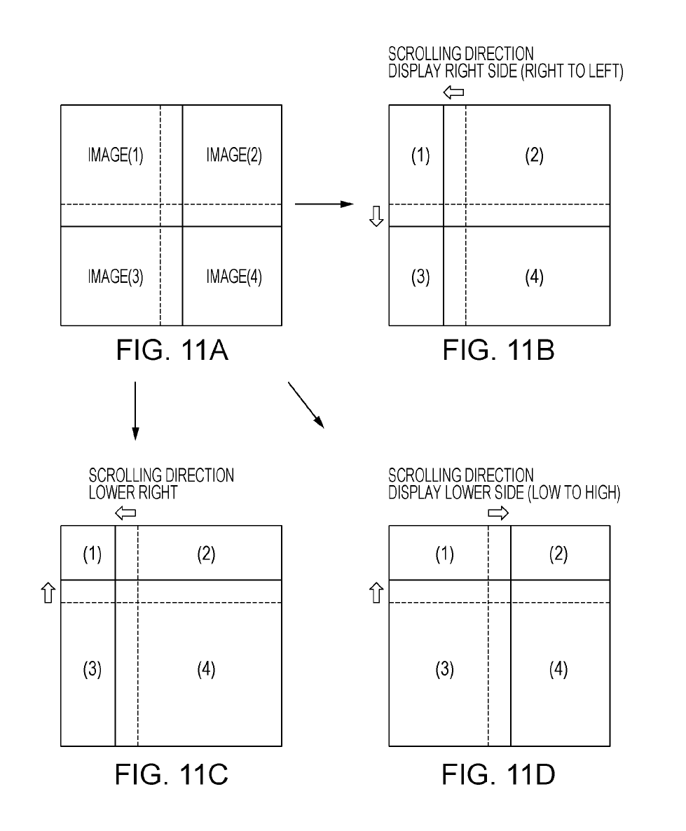

The concept of automatic switching of the priority levels of images performed by the image processing apparatus in the present invention will be described with reference to FIGS. 11A to 11D.

FIG. 11A illustrates an example of configuring image data regarding an imaging target using four pieces of data regarding divided images. For the sake of convenience, numbers, namely an image (1), an image (2), an image (3), and an image (4), are provided for the four pieces of data regarding divided images, respectively, from the upper left to the lower right. In FIG. 11A, a boundary between a piece of data regarding a divided image whose priority level in display is set high and an adjacent piece of data regarding a divided image is indicated by a solid line, whereas a boundary of a piece of data regarding a divided image that is not displayed as an overlap region is indicated by a broken line. In FIG. 11A, it is assumed that the priority level of the image (1) is the highest, the priority levels of the images (2) and (3) are the second highest, and the priority level of the image (4) is the lowest. Therefore, an edge of the image (1) becomes a boundary between the image (1) and the image (2) indicated by a solid line.

FIG. 11B illustrates a change in the display screen at a time when the display screen has been scrolled from the right to the left by an instruction and an operation by the user and the image (2) located at the upper right in FIG. 11A is displayed at the center of the screen. In FIG. 11B, pieces of data regarding divided images captured while dividing an imaging range into a plurality of divided images including overlap regions are selected on the basis of a predetermined display condition and displayed on the display screen. In FIG. 11B, boundaries between the pieces of data regarding divided images displayed in FIG. 11A have been changed as indicated by arrows. Here, the position of the boundary between the image (1) and the image (2) has been changed, and the image (2) takes priority in display.

In addition, FIG. 11C illustrates a display screen after a change at a time when the position of the display screen has been moved in a lower right direction from FIG. 11A, and the boundaries between the pieces of data regarding divided images have been changed as indicated by arrows such that the image (4) takes priority in display.

Furthermore, FIG. 11D illustrates a display screen after a change at a time when the display screen has been moved in a lower direction from FIG. 11A, and the boundaries between the pieces of data regarding divided images have been changed as indicated by arrows such that the image (3) takes priority in display.

One of the following conditions is assumed as the condition of automatic switching of the priority levels of the images illustrated in FIGS. 11A to 11D. A first condition is satisfied when the position of a boundary between pieces of data regarding divided images exceeds the center of the display screen. In this case, the priority levels in displaying an overlap region are changed when the position of the boundary indicated by the solid line in FIG. 11A, which is the boundary between the images (1) and (2), has exceeded the center of the display screen, and the displayed image is automatically switched. A second condition is satisfied when the center of the width of an overlap region between pieces of data regarding divided images exceeds the center of the display screen. The priority levels in display are changed when a position located precisely at the center between the solid line, which is the boundary between the images (1) and (2), and the broken line has exceeded the center of the image displayed in the display region, and display of the overlap region is switched. A third condition for displaying the image is satisfied when the display percentage of a piece of data regarding a divided image exceeds a certain value. A percentage of a piece of data regarding a divided image that occupies the overall image equal to or higher than 25% and lower than or equal to 50% may be set as the certain value. For example, if the display screen changes from FIG. 11A to FIG. 11C, the image (4) takes priority in display when the percentage of the image (4) has exceeded 25%. Accordingly, the positions of boundaries between the images (2) and (4) and the images (3) and (4) are switched. More specifically, the position of a boundary indicated by a solid line is changed to a broken line, and the position of a boundary indicated by a broken line is changed to a solid line. A fourth condition is used when the priority level are to be changed in accordance with the percentage of a piece of data regarding a divided image located at the center of the display screen. For example, when the display screen is configured by nine pieces of data regarding divided images, a piece of data regarding a divided image located at the center may take priority in display.

Generation of Image Data

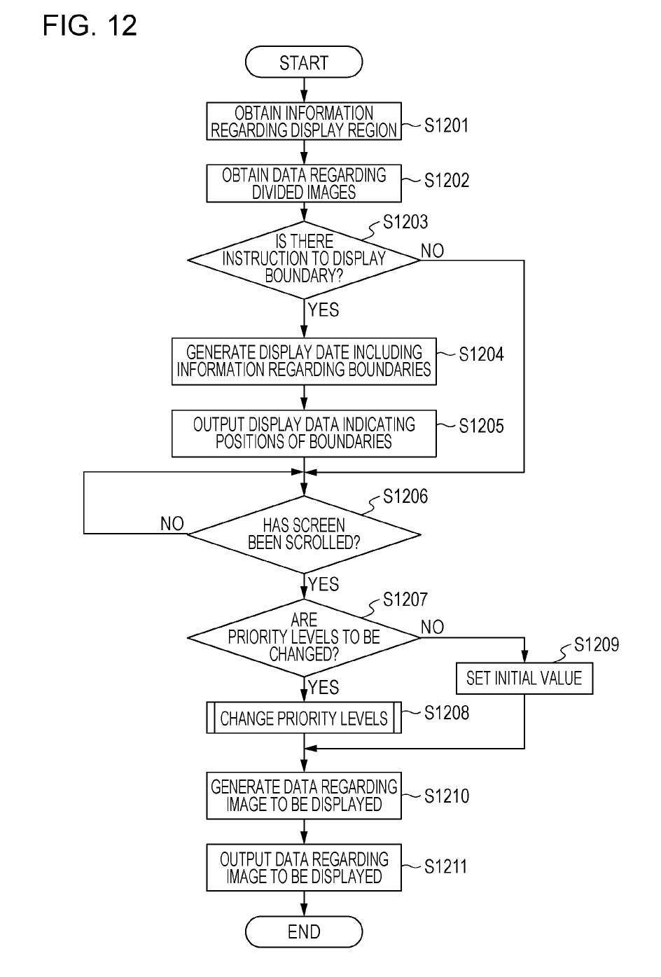

A procedure for generating image data performed by the image processing apparatus in the present invention will be described with reference to a flowchart of FIG. 12.

In step 1201, information (the resolution of a screen) regarding the size of a display area of a display, which is the image display apparatus 103, and information regarding the display magnification of a currently displayed image are obtained. The information regarding the size of the display area is used for determining the size of the region of display data to be generated. The display magnification is information necessary for selecting a piece of image data from hierarchical images.

In step 1202, pieces of data regarding divided images necessary for generating image data to be displayed are obtained from a plurality of pieces of data regarding divided images received by the data input unit 1001 and stored in the memory holding unit 1002. When pieces of data regarding divided images at different magnifications are hierarchically stored or held, pieces of data regarding divided images at an appropriate level are selected on the basis of the information regarding the display region obtained in step 1201.

Processing in step 1203 to step 1205 is the same as the processing in step 603 to step 605 illustrated in FIG. 6 according to the first embodiment, and accordingly description thereof is omitted.

In step 1206, whether or not there has been a change in the display screen such as scrolling is determined. If there has been a change, the procedure proceeds to step 1207. If there has been no change, the determination as to a change in the display screen in step 1206 is made again after an elapse of an appropriate period of time is determined using a timer or the like.

In step 1207, whether or not the priority levels for the overlap regions between the pieces of data regarding divided images need to be changed in accordance with the change in the display screen is determined. The determination as to this necessity is made through a comparison with the conditions described with reference to FIGS. 11A to 11D. If the priority levels are not to be changed, the procedure proceeds to step 1209, and if the priority levels are to be changed, the procedure proceeds to step 1208.

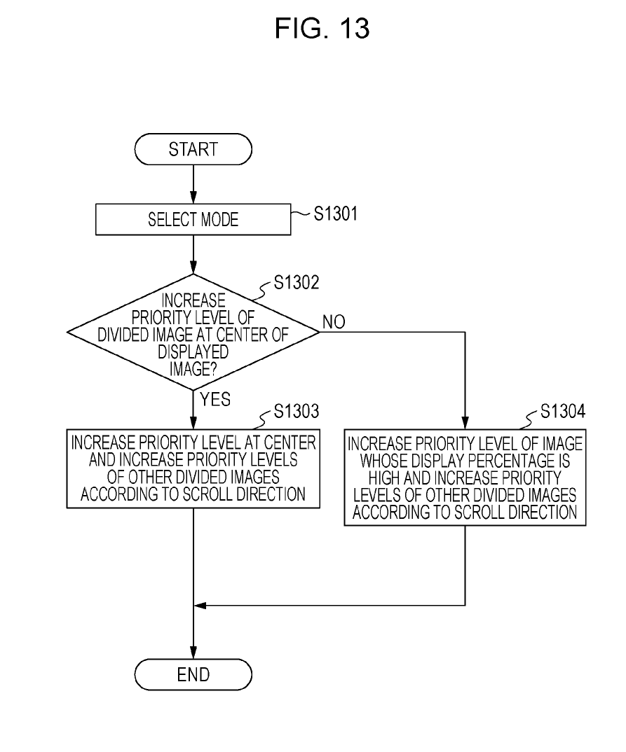

In step 1208, with respect to the overlap regions between the plurality of pieces of data regarding divided images, the priority levels in selecting the overlap regions are corrected as necessary in accordance with the condition. Details of the change of the priority levels will be described with reference to a flowchart of FIG. 13.

In step 1209, initial conditions or the current priority levels are set to the plurality of overlap regions between the pieces of data regarding divided images.

In step 1210, image data to be displayed on the image display apparatus 103 is generated on the basis of the priority levels determined in step 1208 or step 1209. More specifically, image data to be displayed is generated such that overlap regions of pieces of data regarding divided images whose priority levels are high are displayed.

In step 1211, the image data to be displayed generated in step 1210 is transmitted to the image display apparatus 103 or the like through the data output unit 305.

Change of Priority Levels

The change of the priority levels in displaying the overlap regions described in step 1208 illustrated in FIG. 12 will be described with reference to a flowchart of FIG. 13. In FIG. 13, the priority levels in displaying the overlap regions between the pieces of data regarding divided images are increased in consideration of a scrolling direction. As described with reference to FIGS. 11A to 11D, the change of the priority levels is made on the basis of a change in the position of a boundary and the display percentage of an arbitrary piece of data regarding a divided image in the display region.

In step 1301, a display mode in which the plurality of overlap regions between the pieces of data regarding divided images are displayed on the image display apparatus is selected.

In step 1302, whether or not to increase the priority level of a piece of data regarding a divided image located at the center of the display region in display in accordance with a change in the position of a boundary. If the priority level of the divided image located at the center of the display screen region is not to be increased, the procedure proceeds to step 1304, and if the priority level is to be increased, the procedure proceeds to step 1303. Incidentally, when the number of divisions of the screen is 4, selection of any mode does not change the display screen. When the number of divisions is larger than 4, displayed overlap regions change.

In step 1303, the priority is changed such that the display priority of pieces of data regarding divided images in the scrolling direction increases and the display priority level of a piece of data regarding a divided image located at the center of the display screen region in display increases.

In step 1304, the priority levels are changed such that the priority levels of pieces of data regarding divided images in the scrolling direction in display increase and the priority levels of an image whose percentage of a region in which a piece of data regarding a divided image is displayed relative to the display screen region has exceeded a predetermined value in display increases.

In the present embodiment, by automatically changing the priority levels of the pieces of data regarding divided images while detecting the update state of the display screen and by switching the overlap regions for display, it is possible to prevent a situation in which an accurate diagnosis becomes difficult due to the positions of boundaries and regions in a composite image different from an original image.

### Third Embodiment

In a third embodiment, an image processing apparatus that selects and displays image data to be displayed generated by selecting pieces of data regarding divided images or display data regarding a composite image obtained by combining pieces of data regarding divided images in accordance with the usage is used. A composite image is displayed especially when the display magnification is low, and an image is displayed using switching of overlap regions when the display magnification is high. When the display magnification is low, pieces of data regarding divided images are combined using an interpolation process or the like and then a reduced image is generated by converting the resolution and used as image data to be displayed. When the display magnification is high, as described above, image data to be displayed is generated by selecting pieces of data regarding divided images. In doing so, the screen may be smoothly scrolled at a low display magnification and the display magnification may be smoothly changed, and at a high magnification, it is possible to prevent an unintended diagnosis based on an image at a boundary between pieces of data regarding divided images.

Configuration of Image Processing Apparatus

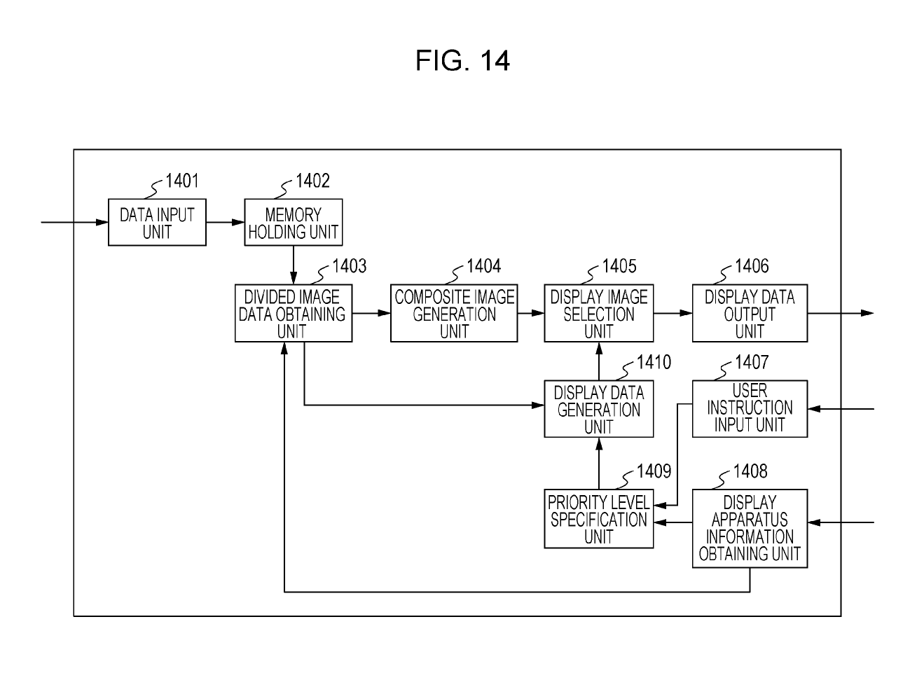

FIG. 14 is a block diagram illustrating the functional configuration of an image processing apparatus 102 according to the third embodiment.

The image processing apparatus 102 is schematically configured by a data input unit 1401, a memory holding unit 1402, a divided image data obtaining unit 1403, a composite image generation unit 1404, a display image selection unit 1405, a display data output unit 1406, and a priority level specification unit 1409.

The memory holding unit 1402 stores or holds data regarding divided RGB color images obtained from the imaging apparatus 101 typified by a virtual slide apparatus or the image server 1601, which is an external apparatus, through the data input unit 1401 by dividing an image of the imaging target and by capturing the divided images. The data regarding color images includes not only image data but also positional information. As described above, the positional information is information indicating a portion of the image region of the entirety of the imaging target whose image has been captured as data regarding a divided image.

The divided image data obtaining unit 1403 obtains data regarding divided images stored in or held by the memory holding unit 1402 and information regarding an image display apparatus and data such as a display region from the display apparatus information obtaining unit 1408.

The composite image generation unit 1404 generates data regarding a composite image of an imaging target from pieces of data regarding color images (pieces of data regarding divided images) obtained by dividing an image of the imaging target and by capturing the divided images on the basis of the positional information regarding each of the pieces of data regarding divided images. Methods for performing a combining process include a method in which the pieces of data regarding partial images are combined with one another, a method in which the pieces of data regarding partial images are superimposed upon one another, a method in which the pieces of data regarding partial images are subjected to alpha blending, and a method in which the pieces of data regarding partial images are smoothly combined with one another using an interpolation process. Methods for combining the plurality of pieces of image data that overlap one another include a method in which the plurality of pieces of image data are positioned and combined with one another on the basis of positional information regarding the stage, a method in which the plurality of pieces of image data are combined with one another while associating corresponding points or lines of the plurality of divided images, and a method in which the plurality of pieces of image data are combined with one another on the basis of the positional information regarding the pieces of data regarding divided images. Superimposing generally refers to disposing a piece of image data on another piece of image data. Methods for superimposing the plurality of pieces of image data include a case in which some or all of the plurality of pieces of image data overlap in a region that includes overlapping pieces of image data. The alpha blending refers to combining two images using a coefficient (α value). Methods for smoothly combining the pieces of data regarding partial images with one another include processing using constant interpolation, processing using linear interpolation, and processing using high-order interpolation. In order to smoothly combine the images with one another, the images are preferably processed using high-order interpolation.

A display data generation unit 1410 generates image data to be displayed on the basis of information obtained by a user specification input unit 1407 and the display apparatus information obtaining unit 1408 along with the priority instructions of the pieces of data regarding divided images specified by the priority level specification unit 1409.

The display image selection unit 1405 selects whether to display data regarding a composite image generated by the composite image generation unit 1404 or image data to be displayed generated by arranging the pieces of data regarding divided images generated by the display data generation unit 1410 on the basis of priority levels without performing a combining process. The selected image data to be displayed is transmitted to an external monitor or the like through the display data output unit 1406 as image data to be displayed.

Generation of Image Data

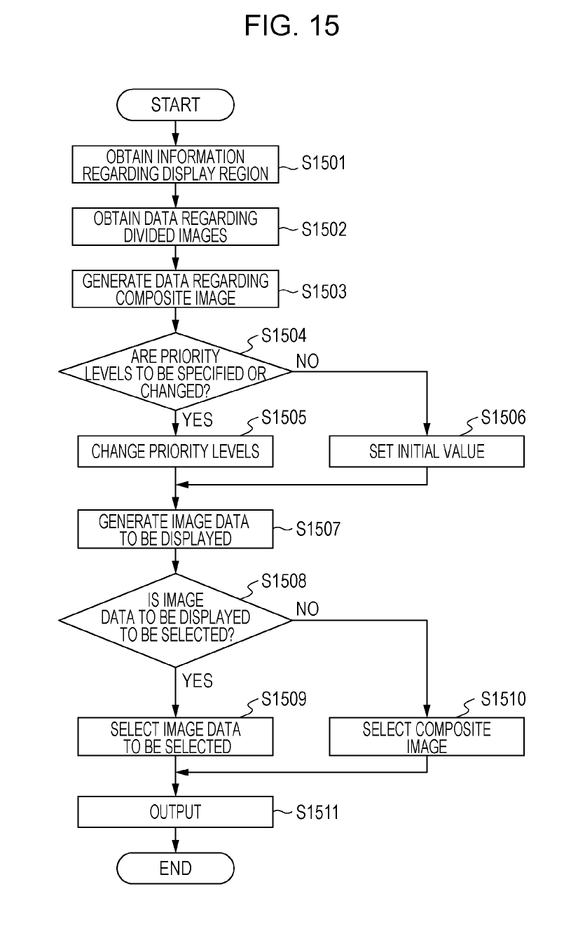

A procedure for generating image data performed by the image processing apparatus in the present invention will be described with reference to a flowchart of FIG. 15.

In step 1501, information (the resolution of a screen) regarding the size of a display area of a display, which is the image display apparatus 103, and information regarding the display magnification of a currently displayed image are obtained. The information regarding the size of the display area is used to determine the size of the region of display data to be generated. The display magnification is information necessary for selecting a piece of image data from hierarchical images.

In step 1502, pieces of data regarding divided images necessary for generating image data to be displayed are obtained from the plurality of pieces of data regarding divided images received by the data input unit 1401 and stored in the memory holding unit 1402. When pieces of data regarding divided images at different magnifications are hierarchically stored or held, pieces of data regarding divided images at an appropriate level are selected on the basis of the information regarding the display region obtained in step 1501. In addition, pieces of data regarding divided images necessary for generating a composite image in step 1503 are obtained.

In step 1503, a process for combining the pieces of data regarding divided images is performed in order to generate data regarding a composite image.

In step 1504, whether or not the priority levels for the overlap regions between the pieces of data regarding divided images need to be changed in accordance with a change in the display screen is determined. If the priority levels are not to be changed, the procedure proceeds to step 1506, and if the priority levels are to be changed, the procedure proceeds to step 1505.

In step 1505, for the overlap regions between the plurality of pieces of data regarding divided images, the priority levels in selecting the overlap regions are changed in accordance with a condition or a user instruction. The priority levels of the pieces of data regarding divided images may be changed in accordance with an instruction from the outside as in the first embodiment or on the basis of a predetermined condition as in the second embodiment.

In step 1506, initial states or the current priority levels are set for the plurality of overlap regions between the pieces of data regarding divided images.

In step 1507, image data to be displayed on the image display apparatus 103 is generated on the basis of the determined priority levels. The image data to be displayed generated here is image data that is generated on the basis of the priority levels in displaying the overlap regions and in which pieces of data regarding divided images are arranged.

In step 1508, whether to select, as image data to be displayed, the composite image generated in step 1503 or the image to be displayed based on the priority levels generated in step 1507 is determined. If the data regarding a composite image is to be selected as the image data to be displayed, the procedure proceeds to step 1510, and if the positions of boundaries are to be changed on the basis of the above-described priority levels and the image data to be displayed in which the pieces of data regarding divided images are arranged is to be selected, the procedure proceeds to step 1509.

In step 1509, the image data to be displayed generated in step 1507 by selecting the pieces of data regarding divided images is selected as the image data to be displayed on the image display apparatus 103.

In step 1510, the data regarding a composite image generated in step 1503 is selected as the image data to be displayed on the image display apparatus 103.

In step 1511, the image data to be displayed selected in step 1509 or 1510 is output to the image display apparatus 103.

In the present embodiment, by selecting and displaying image data to be displayed generated by selecting pieces of data regarding divided images or display data regarding a composite image obtained by combining pieces of data regarding divided images in accordance with the usage, the screen may be smoothly scrolled at a low display magnification and the display magnification may be smoothly changed, and at a high magnification, it is possible to prevent an unintended diagnosis based on an image at a boundary between pieces of data regarding divided images.

### Other Embodiments

An object of the present invention may be achieved by the following manners. That is, a recording medium (or a storage medium) on which a program code of software for realizing all or some of the functions according to the above-described embodiments is recorded is supplied to a system or an apparatus. A computer (or a CPU or an MPU) of the system or the apparatus then reads and executes the program code stored in the recording medium. In this case, the program code itself read from the recording medium realizes the functions according to the above-described embodiments, and the recording medium on which the program code is recorded configures the present invention.

In addition, when the computer has executed the read program code, an operating system (OS) or the like operating on the computer performs a part or all of actual processing on the basis of an instruction from the program code. A case in which the functions according to the above-described embodiments are realized by the processing may also be included in the present invention.

Furthermore, assume that the program code read from the recording medium is written to a function enhancement card inserted into the computer or a memory included in a function enhancement unit connected to the computer. A case in which a CPU or the like included in the function enhancement card or the function enhancement unit then performs a part or all of actual processing on the basis of an instruction from the program code and the functions according to the above-described embodiments are realized by the processing may also be included in the present invention.

When the present invention is applied to the recording medium, the recording medium stores program codes corresponding to the above-described flowcharts.

In addition, the configurations described in the first to third embodiments may be combined with one another. For example, a configuration may be adopted in which an image processing apparatus is connected to both an imaging apparatus and an image server and therefore an image used for processing may be obtained from either apparatus. In addition, configurations obtained by appropriately combining various technologies in the above-described embodiments may also be included in the scope of the present invention.

According to the preferable image processing apparatus, the image display system, the method for processing an image, and the image processing program provided by the present invention, it is possible to prevent a situation in which an accurate diagnosis becomes difficult due to composite positions of a composite image different from an original image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus that generates image data regarding an imaging target to be displayed on the basis of pieces of data regarding divided images of the imaging target obtained by capturing an imaging range such that the pieces of data regarding divided images include overlap regions, the image processing apparatus comprising:
an image data obtaining unit that obtains the plurality of pieces of data regarding divided images;
an image data selection unit that automatically selects, for each of the overlap regions, a piece of image data to be displayed from the plurality of pieces of data regarding divided images on the basis of a predetermined condition; and
a display control unit that displays, on an image display apparatus, each of the overlap regions using the piece of data regarding a divided image selected by the image data selection unit.

2. The image processing apparatus according to claim 1,
wherein the predetermined condition is based on a change in a position of a boundary of the piece of data regarding a divided image to be displayed on the image display apparatus.

3. The image processing apparatus according to claim 1,
wherein the predetermined condition is based on a change in a percentage of display of the piece of data regarding a divided image to be displayed on the image display apparatus.

4. The image processing apparatus according to claim 1,
wherein the image processing apparatus is used in a virtual slide system.

5. The image processing apparatus according to claim 1,
wherein the image data selection unit is also able to select the piece of data regarding a divided image in accordance with an instruction from a user input from an outside.

6. The image processing apparatus according to claim 1, further comprising:
a switching unit that switches, for each of the overlap regions, data to be displayed between image data regarding the imaging target generated by selecting a piece of image data to be displayed from the plurality of pieces of data regarding divided images and data regarding a composite image of the imaging target generated by combining the plurality of divided images.

7. An image display system comprising:
an image processing apparatus; and
an image display apparatus,
wherein the image processing apparatus is the image processing apparatus according to claim 1, and
wherein the image display apparatus selects and displays a divided image on the basis of image data regarding an imaging target transmitted from the image processing apparatus.

8. The image display system according to claim 7,
wherein the image display system displays a boundary of the displayed divided image.

9. A method for processing an image, the method comprising:
an image data obtaining process for obtaining pieces of data regarding divided images of an imaging target obtained by capturing an imaging range such that the pieces of data regarding divided images include overlap regions;
an image data selection process for automatically selecting, for each of the overlap regions, a piece of image data to be displayed from the plurality of pieces of data regarding divided images on the basis of a predetermined condition; and
a display image data generation process for generating, in each of the overlap regions, image data regarding the imaging target using the piece of data regarding a divided image selected in the display image data selection process.

10. A program for causing a computer to execute a process comprising:
an image data obtaining step of obtaining pieces of data regarding divided images of an imaging target obtained by capturing an imaging range such that the pieces of data regarding divided images include overlap regions;
an image data selection step of automatically selecting, for each of the overlap regions, a piece of image data to be displayed from the plurality of pieces of data regarding divided images on the basis of a predetermined condition; and
a display image data generation step of generating, in each of the overlap regions, image data regarding the imaging target using the piece of data regarding a divided image selected in the image data selection step.

11. A computer-readable storage medium in which the program according to claim 10 is recorded.
